(19) United States
(12) Patent Application Publication
(10) Pub. No.: US 2015/0077556 A1
(43) Pub. Date: Mar. 19, 2015

(54) VEHICLE SYSTEM FOR AUTOMATED VIDEO RECORDING

(71) Applicant: FORD GLOBAL TECHNOLOGIES LLC, Dearborn, MI (US)

(72) Inventor: Eric L. Reed, Livonia, MI (US)

(73) Assignee: FORD GLOBAL TECHNOLOGIES, LLC, Dearborn, MI (US)

(21) Appl. No.: 14/026,228

(22) Filed: Sep. 13, 2013

(51) Int. Cl. H04N 7/18

(52) U.S. Cl. CPC H04N 7/183
USPC 348/148

(57) ABSTRACT

A vehicle system for automated recording may include a controller configured to receive a first sensor input to detect an occupant presence. The controller may communicate with a recording device in response to the sensor input. The recording device may activate in response to a positive occupant presence and deactivate in response to a negative occupant presence.

### BACKGROUND

Often, law enforcement agencies outfit vehicles with one or more cameras. Typically, one of these cameras is an interior camera designed with the intent of recording rear seat occupants. This camera can provide valuable video evidence of a perpetrator's behavior at the time of apprehension and while in the law enforcement vehicle. However, interior cameras require manual activation and, as such, may start late or even not run at all, missing relevant evidence. This problem may be countered by allowing the camera to run at all times with the tradeoff being substantial memory storage for the video files and difficulty searching through hours of video for significant relevant facts.

Additionally, the interior of a vehicle typically has insufficient lighting for quality video recording. Providing supplemental lighting in visible wavelengths (e.g., ˜380 nm to 740 nm) in the interior of the vehicle is not viable since excessive interior light can hamper driver vision, especially at night. Some vehicles include an infrared (IR) light source in the front of the vehicle. However, the IR light can be blocked by front seat passengers and/or other equipment installed in the vehicle. Accordingly, there is a need for a camera that automatically activates to record vehicle occupants and provide supplemental illumination if needed.

### SUMMARY

A vehicle system for automated recording may include a controller configured to receive a first sensor input to detect an occupant presence. The controller may communicate with a recording device in response to the sensor input. The recording device may activate in response to a positive occupant presence and deactivate in response to a negative occupant presence.

A vehicle system for automated recording may include a first sensor configured to detect an occupant presence. The system may include a controller in communication with the first sensor configured to communicate with a recording device and a supplemental illuminating device in response to the first sensor, wherein the supplemental illuminating device is positioned in a rear cabin compartment. The controller may activate the recording device and supplemental illuminating device in response to a positive occupant presence and deactivate the recording device and supplemental illuminating device in response to a negative occupant presence.

A method for automated recording of vehicle occupants may include receiving, via a computing device, a first sensor input to detect an occupant presence; communicating with a recording device in response to the first sensor input, wherein the recording device includes at least one of an acoustic device, an illuminating device, and a video device; and activating the recording device in response to a positive occupant presence and deactivating the recording device in response to a negative occupant presence.

### BRIEF DESCRIPTION OF THE DRAWINGS

FIG. 1 illustrates an exemplary automated video recording system for a vehicle;

FIG. 2 illustrates a schematic representation of a supplemental illuminating device for the automated video recording system of FIG. 1;

FIG. 3 illustrates a block diagram of the exemplary components of the automated video recording system of FIG. 1; and

FIG. 4 illustrates an exemplary process for automated recording of a vehicle passenger cabin.

### DETAILED DESCRIPTION

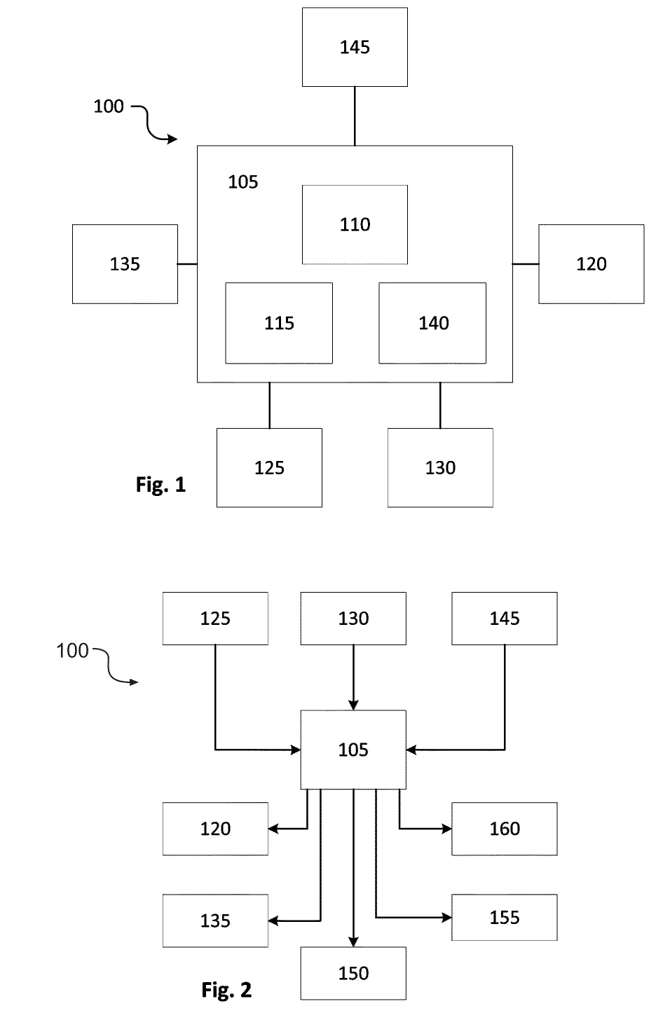

FIG. 1 illustrates an exemplary automated video recording system 100 for a vehicle. The vehicle may be any type of vehicle such as a car, truck, bus, airplane, helicopter, or ship, for example. The system 100 may take many different forms and may include multiple and/or alternate components. While an exemplary system 100 is shown in FIG. 1, the exemplary components illustrated in system 100 are not intended to be limiting. Indeed, additional or alternative components and/or implements may be used.

The system 100 may automate a video recorder in response to detecting a rear occupant presence or absence. The system 100 may likewise apply a supplemental light source to the rear cabin compartment of the vehicle in response to detecting the rear occupant presence. Additionally or alternatively, the supplemental light source may be activated upon detecting insufficient ambient light inside the vehicle cabin.

The system may include a controller 105. The controller 105 may include any computing device configured to execute computer-readable instructions. For example, the controller 105 may include a processor 110 and a module 115. The processor 110 may be integrated with, or separate from, the controller 105. Additionally or alternatively, there may be multiple controllers 105, each including a processor 110 and a module 115.

In general, computing systems and/or devices, such as the controller 105 and processor 110, may employ any number of computer operating systems, including, but not limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating system distributed by Apple, Inc. of Cupertino, Calif., the Blackberry OS distributed by Research in Motion of Waterloo, Canada, and the Andriod operating system developed by the Open Handset Alliance. It will be apparent to those skilled in the art from the disclosure that the precise hardware and software of the controller 105 and processor 110 may be any combination sufficient to carry out the functions of the embodiments discussed herein.

The controller 105, via the processor 110, may be configured to control various systems and components within the vehicle. The processor 110 may be configured to execute one or more processes for controlling the system 100. Additionally or alternatively, the controller 105 may include various modules 115, each configured to communicate with the processor 110 via a gateway module 115.

The controller 105 may be in communication with a recording device 120. The recording device 120 may include an acoustic device (e.g., a microphone), a video device, and an illuminating device. The illuminating device may include, for example, an infrared (IR) light-emitting diode (LED). The acoustic device, video device, and illuminating device may be incorporated into the recording device 120. Alternatively, the acoustic device, video device, and illuminating device may form separate components all in communication with the controller 105. The recording device 120 may be configured to overlook the rear passenger cabin of the vehicle. The recording device 120, via the controller 105, may be activated and deactivated in response to an occupant entering and exiting the rear passenger cabin, respectively. Activating the recording device 120 may prompt activation of the acoustic device, video device, and illuminating device. Alternatively, a driver or user may customize the recording device 120 preferences such that only some of the components activate automatically. For example, activating the recording device 120 may activate the acoustic and video device, whereas the illuminating device may standby for additional commands.

The controller 105 may control the recording device 120 in response to a first or seat occupant sensor 125 and a second or ambient light sensor 130. The controller 105 may receive input from a single sensor 125, or multiple sensors 125, 130. For example, the controller 105 may communicate with the recording device 120 in response to a third and fourth sensor (not shown). Alternatively, the module 115 may receive input from sensors 125, 130, which may in turn be communicated to the processor 110. The module 115, recording device 120, and sensors 125, 130 may be in communication with the controller 105 via an interface (not shown). The interfaces may include an input/output system configured to transmit and receive data from the respective components. The interface may be one-directional such that data may only be transmitted in one direction, e.g., from the controller 105 to the sensors 125, 130, or vice versa. Alternatively, the interface may be bi-directional, allowing both sending and receiving data between components.

First and second sensors 125, 130 may include any seat occupant and ambient light sensor and sensor system available in the vehicle. For example, the seat occupant sensor 125 may include an occupant classification system (OCS) sensor, a seat belt monitoring sensor, an interior imaging camera, a door ajar sensor, and/or an ultrasonic sensor. The ambient light sensor 130 may include a sunload sensor and photoelectric sensor. For example, the sunload sensor—typically used in conjunction with an autolamp feature to automatically turn on the vehicle headlights—may be utilized to determine if ambient lighting is sufficient in the vehicle for video recording.

The controller 105, via the processor 110, may be configured to detect the presence of an occupant in response to receiving sensor 125 input. For instance, the controller 105 may communicate with the OCS sensor to detect a pressure or weight on the seat indicating a passenger is present. Additionally, the controller 105 may communicate with a door ajar sensor or ultrasonic sensor to further validate a passenger has entered the vehicle. In the event the first sensor 125 detects an occupant is present in the rear passenger cabin, for example, the sensor 125 may transmit a positive occupant presence to the controller 105. On the other hand, the sensor 125 may communicate a negative occupant presence to the controller 105 in the event an occupant is not detected.

The controller 105 may be configured to activate the recording device 120 upon receiving a positive occupant presence. Using the seat occupant sensor 125 (e.g., OCS, seat belt monitoring sensor, ultrasonic sensor, etc.), the controller 105 may alert the recording device 120 to the presence of a rear seat passenger and activate the various components of the recording device 120. Thus, the recording device 120 may be configured to monitor the rear passenger compartment upon activation. The recording device 120 may continue to monitor the rear passenger compartment until the controller 105 detects a negative occupant presence via the first sensor 125. For example, the controller 105 may deactivate the recording device 120 in response to detecting the door ajar and pressure not being exerted on a rear passenger seat, via the OCS sensor. Thus, the sensor 125 may communicate a negative occupant presence to the controller 105 in the event an occupant leaves the vehicle.

The controller 105 may be configured to communicate with a supplemental illuminating device 135 in response to the second sensor 130. The supplemental illuminating device 135 may include an IR LED light configured in the rear passenger compartment. The supplemental illuminating device 135 may be activated in response to ambient light conditions detected by the second sensor 130. For instance, a sunload sensor 130 may detect ambient lighting in the rear passenger compartment to determine if additional IR lighting is necessary. In the event ambient lighting is insufficient for quality video recording, the controller 105 may activate the supplemental illuminating device 135. Alternatively, the amount of illumination emitted from the supplemental illuminating device 135 and the illuminating device of the recording device 120 may be regulated by the controller 105 based on the ambient light reading from the second sensor 130 (e.g., photoelectric or sunload sensor) using pulse-width modulation (PWM), for example. The controller 105 may direct the supplemental illuminating device 135 to adjust the intensity of the IR LED in response to the second sensor 130 reading. Therefore, the intensity of IR emitted from the supplemental illuminating device 135 may be based in part on the existing ambient light conditions. The controller 105 may deactivate the supplemental illuminating device 135 in response to detecting a negative occupant presence. Additionally or alternatively, the controller 105 may deactivate the supplemental illuminating device 135 in response to the ambient light sensor 130 detecting sufficient ambient light conditions.

In an embodiment, the illuminating device of the recording device 120 and the supplemental illuminating device 135 may be activated in response to the rear occupant sensor 125 detecting a positive occupant presence. For instance, the controller 105 may activate the recording device 120 and supplemental illuminating device 135 in response to the first sensor 125 detecting an occupant has entered the cabin compartment. Likewise, the controller 105 may deactivate the recording device 120 and supplemental illuminating device 135 in response to a negative occupant presence detected by the first sensor 125. Thus, the controller 105 may instruct both the recording device 120 and supplemental illuminating device 135 to activate or deactivate in response to the rear occupant sensor 125.

The supplemental illuminating device 135 and the illumination device of the recording device 120 may operate independently of one another. The illuminating device of the recording device 120 may be activated when the supplemental illuminating device 135 is deactivated, and vice versa. Further, the illuminating device of the recording device 120 may be activated in response to the rear seat occupant sensor 125 while the supplemental illuminating device 135 may be activated in response to the ambient light sensor 130. In yet another example, both the illuminating device of the recording device 120 and the supplemental illuminating device 135 may be activated in response to the ambient light sensor 130.

The controller 105 may be configured to receive various inputs and generate and deliver various outputs in accordance with the inputs received or computer-executable instructions maintained in a database 140. The database 140 may be comprised of a flash memory, RAM, EPROM, EEPROM, hard disk drive, or any other memory type or combination thereof. The database 140 may store audio and video data documented while the recording device 120 is activated in long-term memory (e.g., nonvolatile memory) or Keep Alive Memory (KAM). Likewise, the database 140 may maintain an alert message and command associated with the activation and deactivation of the recording device 120 and supplemental illuminating device 135 to override the controller 105 instructions. For example, the command may appear on a vehicle display 145, which may be configured to receive user input to allow or disallow the automated recording system 100 to operate.

The controller 105 may activate and deactivate the database 140 in response to activating the recording device 120. For example, the database 140 may operate while the recording device 120 is active, and may be inoperative when the recording device 120 is deactivated. In this manner, the database 140 may use less storage space since the database 140 does not maintain data that may be meaningless to the user/driver (e.g., video recording of an empty seat).

The controller 105 may be in communication with a vehicle display 145. The vehicle display 145 may include a single type display, or multiple display types (e.g., audio and visual) configured for human-machine interaction. The vehicle display 145 may be configured to receive user inputs from the vehicle occupants. It may include, for example, control buttons and/or control buttons displayed on a touchscreen display which enable the user to enter commands and information for use by the controller 105 to control the various systems of the vehicle. The vehicle display 145 may also include a microphone that enables the user to enter commands or other information vocally.

The controller 105 may be configured to present an alert and command to the vehicle display 145. An alert may include an indication that the recording device 120 and/or the supplemental illuminating device 135 have been activated or deactivated. The alert message may be associated with the recording device 120 and supplemental illuminating device 135 activation and deactivation and may be predefined by the original equipment manufacturer (OEM) or customizable by the driver. Additionally, the command may be associated with the alert message allowing the driver to manually override the activation for deactivation of the recording device 120. For instance, the command may appear on the vehicle display 145 (e.g., a human-machine interface), which may be configured to receive user input to allow or disallow the feature usage deactivation.

FIG. 2 illustrates a diagram of the exemplary inputs and outputs of the controller 105 for system 100. The controller 105 may monitor seat occupancy and ambient light from inputs received from the seat occupant sensor 125 and ambient light sensor 130. For example, the controller 105 may detect a positive or negative occupancy presence from the seat occupant sensor 125. Likewise, the controller 105 may detect ambient light from the ambient light sensor 130 to determine if ambient lighting is sufficient for video recording of the rear passenger seat. Additionally, the controller 105 may be configured to receive user input from the vehicle display 145 in the event a system 100 override is desired.

The controller 105 may use the inputs received from the seat occupant sensor 125, ambient light sensor 130, and vehicle display 145 to determine which components should be activated or deactivated. For example, the controller 105 may activate the recording device 120 and integrated components, such as the acoustic device 150, illuminating device 155, and video device 160, in response to detecting a positive occupant presence from the seat occupant sensor 125. Likewise, the controller 105 may activate the illuminating device 155 in response to the ambient light sensor 130, such that the illuminating device 155 is on when the ambient light is insufficient for video recording. Additionally, the controller 105 may activate the supplemental illuminating device 135 in response to input from the seat occupant sensor 125 of a positive occupant presence, or in response to the ambient light sensor 130, or in response to both sensors 125, 130. For example, the supplemental illuminating device 135 may activate in response to a positive occupant presence and the controller 105 may regulate the power supplied to the supplemental illuminating device 135 (e.g., IR LED intensity) in response to the ambient light sensor 130 reading. The controller 105 may deactivate the supplemental illuminating device 135, recording device 120 and related components 150, 155, and 160 in response to detecting a negative occupancy presence from the seat occupant sensor 125.

The supplemental illuminating device 135 and the illuminating device 155 integrated with the recording device 120 may operate dependently or independently of one another. The illuminating device 155 may activate when the supplemental illuminating device 135 is deactivated, and vice versa. Further, the illuminating device 155 may activate in response to the rear seat occupant sensor 125 while the supplemental illuminating device 135 may activate in response to the ambient light sensor 130. In yet another example, both the illuminating device 155 and the supplemental illuminating device 135 may activate in response to input from the ambient light sensor 130.

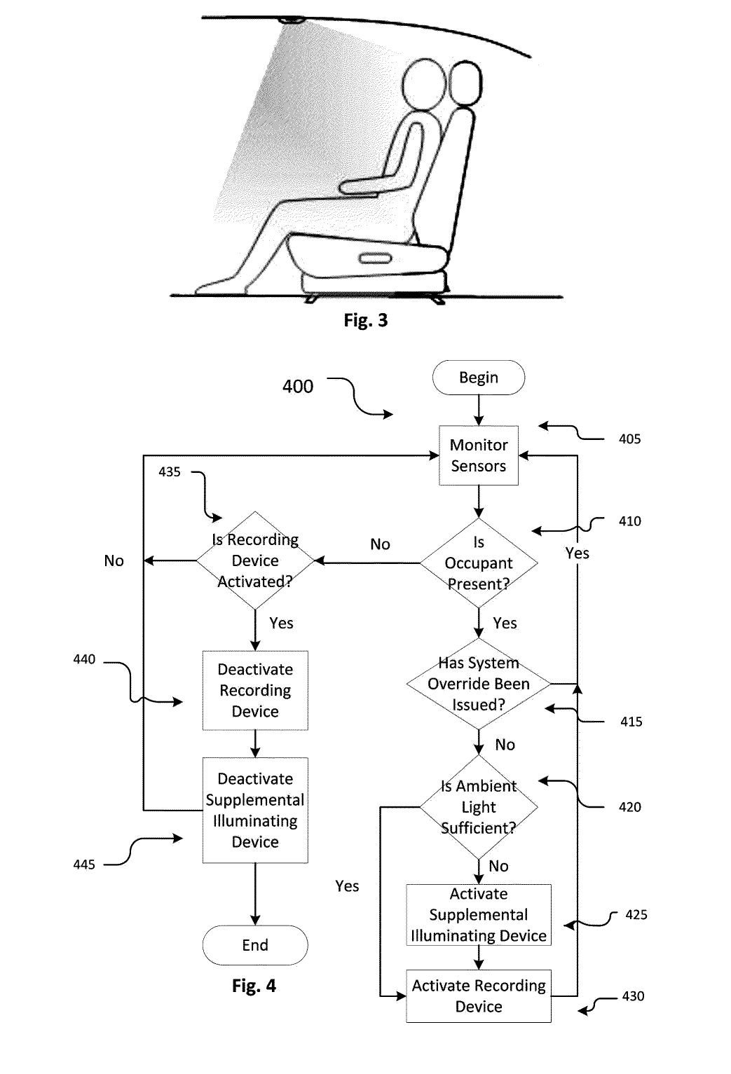

FIG. 3 illustrates a schematic representation of the supplemental illuminating device 135 for the automated recording system 100. In an embodiment, the supplemental illuminating device 135 may be positioned in the rear cabin compartment. The supplemental illuminating device 135 may integrate inexpensively into the existing vehicle dome and/or existing map lamps for the rear seating position. Thus, the supplemental illuminating device 135 may be positioned above the occupant. Such integration into the existing light structures may allow for the benefits of supplemental lighting to be used without requiring additional vehicle packaging space or wiring. Additionally, the illumination will not be blocked by the front seat passengers and/or other equipment installed in the vehicle.

FIG. 4 is an exemplary process 400 for automated recording of a vehicle passenger cabin. The process begins at block 405. At block 405, the controller 105 may monitor the sensors 125,130 on the vehicle. The process 400 may begin automatically as the vehicle ignition may be on and the engine running Alternatively, the ignition may be off, at which point the process 400 may begin when the controller 105 “wakes-up”. The controller 105 may wake-up periodically in order to establish communication between the sensors 125, 130 and the controller 105. For example, the user/driver may touch or toggle a handle of the door of the vehicle or push a button on a vehicle key fob (not shown) which are all recognized by the controller 105. The controller 105 may monitor the rear seat occupant sensor 125 and ambient light sensor 130. For example, the ambient light sensor 130 may detect ambient IR light is high, as in the middle of the day. The controller 105 may be configured to continually monitor the sensors 125, 130. The process 400 may proceed to block 410.

At block 410, the controller 105 may determine the presence of a rear seat passenger via the seat occupant sensor 125. The seat occupant sensor 125 may include an OCS sensor, seat belt monitoring sensor, door ajar sensor, ultrasonic sensor, or interior imaging camera. Additionally, the controller 105 may use multiple sensor 125 inputs to determine the presence of a rear seat passenger. For example, the controller 105 may communicate with the rear seat OCS sensor, door ajar sensor, and interior imaging camera to determine the presence of a rear seat occupant. In the event the sensor 125 determines the rear cabin is unoccupied, the sensor 125 may communicate a negative occupant presence to the controller 105 and the process 400 may proceed to step 435. On the other hand, in the event the controller 105 detects a positive occupant presence in the rear cabin compartment, via the sensor 125, the process 400 may proceed to block 415.

At block 415, the controller 105 may present an alert to the vehicle display 145 indicating the recording device 120 may activate in response to detecting the positive occupant presence. The alert may include an associated command allowing the driver to manually override activation of the recording device 120. For example, the alert and command may appear on the vehicle display 145 allowing the driver to press a control button (e.g., a soft button on a touchscreen display) in the event an override is desired. The alert and command may then disappear after a predefined duration (e.g., 10 s) and the process 400 may continue if a user input is not detected. Alternatively, the alert and command may require user input in order to proceed (e.g., Press “YES” to activate and “NO” to override). If the controller 105 detects a manual override via user input on the vehicle display 145, the process may return to block 405. However, if an override is not detected, the process 400 may continue to block 420.

At block 420, the controller 105 may determine the ambient lighting condition in response to the ambient light sensor 130. The controller 105 may communicate with the second or ambient light sensor 130, for example a sunload sensor or photoelectric sensor, to determine if insufficient ambient light exists for video recording. For instance, low levels of light source detected by the ambient light sensor 130 may indicate additional IR light is needed. Further, the controller 105 may detect the extent to which additional illumination may be needed based on the ambient light reading from the ambient light sensor 130. If the ambient light sensor 130 detects lighting conditions are sufficient, the supplemental illuminating device 135 may remain off and the process 400 may proceed to block 430. In the event ambient light is insufficient, or better lighting may be achieved by an artificial source, the process 400 may proceed to block 425.

At block 425, the controller 105 may activate the supplemental illuminating device 135. The controller 105 may be configured to activate the supplemental illuminating device 135 to full strength, or may use PWM to regulate the amount of illumination emitted by the supplemental illuminating device 135. Alternatively, the supplemental illuminating device 135 may activate in response to the seat occupant sensor 125 detecting a positive occupant presence. That is, the supplemental illuminating device 135 may activate without regard to the ambient light sensor 130.

At block 430, the controller 105 may activate the recording device 120 in response to the first sensor 125 detecting the positive occupant presence. In other words, the presence of a rear seat occupant may trigger the controller 105 to activate the recording device 120 and related components. Activating the recording device 120 may include activating the acoustic device 150, illuminating device 155, and the video device 160. Alternatively, the illuminating device 155 may activate in response to the ambient light sensor 130 detecting insufficient ambient lighting conditions. If lighting conditions are sufficient for quality video and recording, the illuminating device 155 may not activate along with the recording device 120. Alternatively, the controller 105, via the ambient light sensor 130, may activate the illuminating device 155 and deactivate the supplemental illuminating device 135. Alternatively, the controller 105 may activate the supplemental illuminating device 135 in lieu of the illuminating device 155 in response to the light reading of the ambient light sensor 130. Further, the database 140 may be configured to maintain the audio/video recording upon activation of the recording device 120. The process 400 may return to block 405 to continue monitoring the sensors 125, 130 while the recording device 120 is activated. The recording device 120 may remain activated (e.g., continue recording the vehicle occupants) until the first sensor 125 detects a negative occupant presence.

In the event the controller 105 detects a negative occupant presence (e.g., the rear passenger seats are vacant), the process 400 may proceed to block 435. At block 435, the controller 105 may determine if the recording device 120 is activated. If the controller 105 detects a negative occupant presence and the recording device 120 is not activated, the controller 105 may determine that action need not be taken and the process 400 may return to block 405 to monitor the sensors 125, 130 in the vehicle. On the occasion that a negative occupant presence is detected and the recording device 120 is activated (e.g., an occupant being recorded has exited the vehicle), the process 400 may proceed to block 440 and deactivate the recording device 120 and various components. For example, the controller 105 may deactivate the video device 150, illuminating device 155, and audio device 160 integrated into the recording device 120. Likewise, the controller 105 may deactivate the database 140 and store the recorded video/audio data. At block 445, the controller 105 may deactivate the supplemental illuminating device 135. The process 400 may then return to block 405 to monitor the sensors 125, 130 in the vehicle. The process 400 may end with the vehicle ignition is off and the controller 105 does not detect a “wake-up” signal.

Computing devices, such as the vehicle control modules, sensors, interfaces, etc., generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer-readable media associated therewith (e.g., disks, memories, etc.). A computer program product may comprise such instructions stored on computer-readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, the use of the words “first,” “second,” etc. may be interchangeable.

What is claimed is:

1. A vehicle system for automated recording comprising:
a controller configured to:
receive a first sensor input to detect an occupant presence; and
communicate with a recording device in response to the sensor input, wherein the recording device activates in response to a positive occupant presence and deactivates in response to a negative occupant presence.

2. The system of claim 1, wherein the first sensor input includes a seat occupant sensor input.

3. The system of claim 1, wherein the recording device includes at least one of an acoustic device, an illuminating device, and a video device.

4. The system of claim 3, wherein the controller receives a second sensor input configured to determine an ambient light source.

5. The system of claim 4, wherein the illuminating device activates in response to the second sensor input.

6. The system of claim 1, wherein the controller communicates with a supplemental illuminating device positioned in a rear cabin compartment.

7. The system of claim 6, wherein the supplemental illuminating device activates in response to the first sensor input detecting a positive occupant response and deactivates in response to the first sensor input detecting a negative occupant response.

8. The system of claim 6, wherein the supplemental illuminating device activates in response to the second sensor input detecting an insufficient ambient light source.

9. The system of claim 8, wherein the controller regulates power supplied to the supplemental illuminating device in response to the second sensor.

10. The system of claim 1, wherein the controller is configured to instruct a user interface device to display an alert indicating the recording device activation and deactivation in response to the first sensor input.

11. The system of claim 10, wherein the user interface device is configured to override the recording device activation and deactivation in response to a user input.

12. A vehicle system for automated recording comprising:
a first sensor configured to detect an occupant presence;
a controller in communication with the first sensor configured to:
communicate with a recording device and a supplemental illuminating device in response to the first sensor, wherein the supplemental illuminating device is positioned in a rear cabin compartment;
activate the recording device and supplemental illuminating device in response to a positive occupant presence; and
deactivate the recording device and supplemental illuminating device in response to a negative occupant presence.

13. The system of claim 12, wherein the recording device includes at least one of an acoustic device, an illuminating device, and a video device.

14. The system of claim 12, further comprising a second sensor configured to determine an ambient light source.

15. The system of claim 14, wherein the supplemental illuminating device activates in response to the second sensor detecting an insufficient ambient light source.

16. The system of claim 14, wherein the controller regulates power supplied to the supplemental illuminating device in response to the second sensor.

17. The system of claim 12, further comprising a user interface device in communication with the controller configured to display an alert indicating the activation and deactivation of the recording device in response to the first sensor.

18. A method for automated recording of vehicle occupants comprising:
receiving, via a computing device, a first sensor input to detect an occupant presence;
communicating with a recording device in response to the first sensor input, wherein the recording device includes at least one of an acoustic device, a first illuminating device, and a video device; and
activating the recording device in response to a positive occupant presence and deactivating the recording device in response to a negative occupant presence.

19. The method of claim 18, further comprising receiving a second sensor input configured to determine an ambient light source.

20. The method of claim 18, wherein the controller communicates with a supplemental illuminating device.

21. The method of claim 20, wherein the supplemental illuminating device activates in response to the first sensor detecting a positive occupant presence and deactivates in response to the first sensor detecting a negative occupant presence.

22. The method of claim 20, wherein the supplemental illuminating device activates in response to the second sensor detecting an insufficient ambient light source.
